(19) United States
(12) Patent Application Publication
(10) Pub. No.: US 2023/0398988 A1
(43) Pub. Date: Dec. 14, 2023

(54) DRIVER ASSISTANCE TECHNOLOGY ADJUSTMENT BASED ON DRIVING STYLE

(71) Applicant: Ford Global Technologies, LLC, Dearborn, MI (US)

(72) Inventors: Jordan Barrett, Milford, MI (US); Andrew Denis Lewandowski, Sterling Heights, MI (US); Keith Weston, Canton, MI (US); Brendan Francis Diamond, Grosse Pointe, MI (US)

(73) Assignee: Ford Global Technologies, LLC, Dearborn, MI (US)

(21) Appl. No.: 17/835,012

(22) Filed: Jun. 8, 2022

(51) Int. Cl. B60W 30/16; B60W 30/12

(52) U.S. Cl. CPC B60W 30/162; B60W 30/12; B60W 2554/802; B60W 2520/10; B60W 2520/18; B60W 2540/30; B60W 2540/12; B60W 2540/229; B60W 2720/106; B60W 2540/043; B60W 2420/42; B60W 2556/05

(57) ABSTRACT

A system and method to a vehicle control assist system of a vehicle to an operator of the vehicle includes: retrieving stored driver assistance settings of an identified operator for the vehicle control assist system of the vehicle; collecting operating behavior data about the identified operator during vehicle operation; and selecting a driver assistance setting of a vehicle control assist system based on inputting the operating behavior data of the identified operator to a machine learning program that has been trained with operating behavior data of a plurality of other operators collected during operation of a plurality of respective vehicles, wherein metadata about the other operators have values in common with the metadata of the identified operator.

### BACKGROUND

Driver assistance technology (DAT), such as adaptive cruise control (ACC), intelligent adaptive cruise control (iACC), and lane keep assist (LCA), is increasingly being provided on vehicles. However, when the operating parameters of these driver assistance technologies does not match a user's driving style, they may be disabled or not used.

### BRIEF DESCRIPTION OF THE DRAWINGS

FIG. 1 is a diagram of an example system for adjusting vehicle DAT based on driving style.

FIG. 2 is a flow diagram for a process for adjusting vehicle DAT based on driving style.

FIGS. 3A, 3B, 3C, and 3D are flow diagrams for processes of adjusting ADAS settings based on driving style and other data.

FIGS. 4A, 4B, 4C, and 4D are flow diagrams for processes of adjusting ADAS settings based on driving style and other data.

### DETAILED DESCRIPTION

Implementations of the present disclosure may adapt advanced driver assistance systems (ADAS) of a vehicle to an operator based on the operator's driving style and other characteristics. For example, driver assistance settings of a vehicle control assist system may be used to control the operation of the driver assistance technology (DAT). A vehicle can load customized driver assistance settings. Data about the operator (of age, driving experience, etc.) and driving style (vehicle operating data) is collected and applied to a machine learning (ML) program that is trained with vehicle operating data from a plurality of other operators having similar/matching data (i.e., crowd-sourced data). The ML program is used to select driver assistance settings. By using crowd data of other operators with similar/matching data (i.e., having values in common) to train the ML program, useful adaptations, e.g., within desired operating parameters of the ADAS or vehicle control assist system, may be realized sooner. A selected driver assistance setting associated with the identity of the operator can be used to adapt the ADAS or vehicle control assist system of the vehicle to operator's driving style so that the operator may be more likely to use the DAT of the vehicle. Any settings selected by the system can be bounded to ranges determined to be within specified operating parameters of the vehicle by the manufacturer (i.e., those ranges selectable by the operator within the HMI for manual selection).

In one or more implementations, a system may include a vehicle computer having a processor and a memory storing instructions executable by the processor to: retrieve stored driver assistance settings of an identified operator; collect operating behavior data about the identified operator during vehicle operation; and select a driver assistance setting of a vehicle control assist system based on inputting the operating behavior data of the identified operator to a machine learning program trained with operating behavior data of a plurality of other operators collected during operation of a plurality of respective vehicles, wherein metadata about the other operators have values in common with metadata of the identified operator.

In an example, the operating behavior data of the identified operator and the other operators may include one or more of a following distance, a speed or slew rate of taking curves or corners, a speed relative to posted speed limits, a lane position, lane change behavior, acceleration behavior, braking behavior, operator drowsiness/alertness, and driving conditions.

In another example, the driver assistance setting may be one or more of a following distance of an adaptive cruise control, a cornering speed of the adaptive cruise control, a slew rate of the adaptive cruise control, an acceleration or deceleration rate of the adaptive cruise control, a speed limit tolerance of the adaptive cruise control, a lane change setting of an adaptive cruise control, and a lane keeping position of a lane keep assist.

In a further example, the metadata of the identified operator and other operators may include age, amount of driving experience, amount of driving experience with the vehicle, and/or recent driving events.

In an example, the instructions executable to collect metadata of the identified operator may retrieve the metadata of the identified operator from a user device of the identified operator.

In another example, the instructions executable to retrieve stored driver assistance settings may include instructions to retrieve pre-set driver assistance settings based upon identifying occupants in the vehicle other than the operator. Optionally in this example, the pre-set driver assistance settings may include pre-set driver assistance settings based upon identification of a pet as an occupant, identification of a child as an occupant, and/or identification of an elderly individual as an occupant.

In a further example, the instructions executable to retrieve stored driver assistance settings may include instructions to retrieve pre-set driver assistance settings based upon identifying poor driving conditions.

In an example, the system may also include instructions executable to identify occupants of the vehicle using at least one of a camera and a user device.

In another example, the instructions to retrieve at least one of the stored driver assistance settings and the metadata of the operator may include instructions to wirelessly accesses a remote database.

In one or more implementations, a method to adjust a vehicle control assist system of a vehicle may include: retrieving stored driver assistance settings of an identified operator for the vehicle control assist system of the vehicle; collecting operating behavior data about the identified operator during vehicle operation; and selecting a driver assistance setting of a vehicle control assist system based on inputting the operating behavior data of the identified operator to a machine learning program that has been trained with operating behavior data of a plurality of other operators collected during operation of a plurality of respective vehicles, wherein metadata about the other operators have values in common with the metadata of the identified operator.

In an example method, the operating behavior data of the identified operator and the other operators may include one or more of a following distance, a speed or slew rate of taking curves or corners, a speed relative to posted speed limits, a lane position, lane change behavior, acceleration behavior, braking behavior, operator drowsiness/alertness, and driving conditions.

In another example method, the driver assistance setting may be one or more of a following distance of an adaptive cruise control, a cornering speed of the adaptive cruise control, a slew rate of the adaptive cruise control, an acceleration or deceleration rate of the adaptive cruise control, a speed limit tolerance of the adaptive cruise control, a lane change setting of an adaptive cruise control, and a lane keeping position of a lane keep assist.

In a further example method, the metadata of the identified operator and other operators may include age, amount of driving experience, amount of driving experience with the vehicle, and/or recent driving events.

In an example method, the retrieving of the metadata of the identified operator may include retrieving the metadata of the identified operator from a user device of the identified operator.

In another example method, the retrieving of stored driver assistance settings may include retrieving pre-set driver assistance settings based upon identifying other occupants in the vehicle. Optionally in this method, the pre-set driver assistance settings may include pre-set driver assistance settings based upon identification of a pet as an occupant, identification of a child as an occupant, and/or identification of an elderly individual as an occupant.

In an example method, the retrieving of the stored driver assistance settings may include retrieving pre-set driver assistance settings based upon identifying poor driving conditions.

An example method may further include identifying of the occupants of the vehicle using at least one of a camera and a user device.

In a further example method, the retrieving of at least one of the stored driver assistance settings and the metadata of the operator may include wirelessly accessing a remote database.

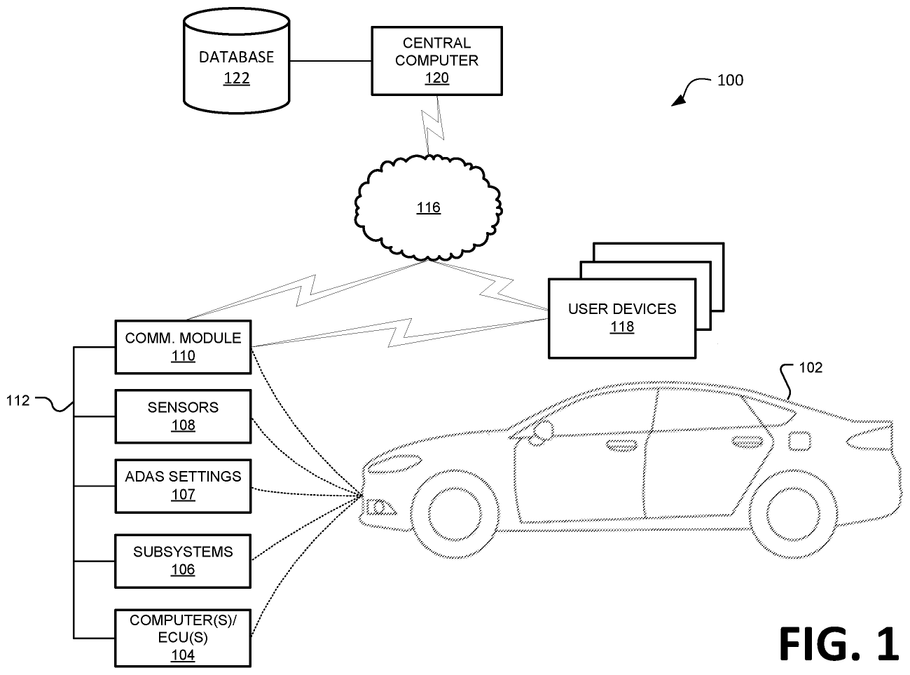

With reference to FIG. 1, a connected vehicle system 100 can provide communications between a vehicle 102, one or more user devices 118 (smartphone, tablet, smartwatch, smart keyfob, tracking device such as an Apple® AirTag, Tile®, etc.), and a central computer 120 to share data among the various entities.

Vehicle 102 is a set of components or parts, including hardware components and typically also software and/or programming, to perform a function or set of operations in the vehicle 102. Vehicle subsystems 106 typically include a braking system, a propulsion system, and a steering system as well as other subsystems including but not limited to a body control system, a climate control system, a lighting system, and a human-machine interface (HMI) system, which may include an instrument panel and/or infotainment system. The propulsion subsystem converts energy to rotation of vehicle 102 wheels to propel the vehicle 102 forward and/or backward. The braking subsystem can slow and/or stop vehicle 102 movement. The steering subsystem can control a yaw, e.g., turning left and right, maintaining a straight path, of the vehicle 102 as it moves.

Computers, including the herein-discussed one or more vehicle computers or electronic control units (ECUs) 104 (sometimes referred to herein as vehicle computer 104), processors in user devices 118, and central computer 120, include respective processors and memories. A computer memory can include one or more forms of computer readable media, and stores instructions executable by a processor for performing various operations, including as disclosed herein. For example, the computer can be a generic computer with a processor and memory as described above and/or an ECU, controller, or the like for a specific function or set of functions, and/or a dedicated electronic circuit including an ASIC that is manufactured for a particular operation, e.g., an ASIC for processing sensor data and/or communicating the sensor data. In another example, computer may include an FPGA (Field-Programmable Gate Array) which is an integrated circuit manufactured to be configurable by a user. Typically, a hardware description language such as VHDL (Very High-Speed Integrated Circuit Hardware Description Language) is used in electronic design automation to describe digital and mixed-signal systems such as FPGA and ASIC. For example, an ASIC is manufactured based on VHDL programming provided pre-manufacturing, whereas logical components inside an FPGA may be configured based on VHDL programming, e.g., stored in a memory electrically connected to the FPGA circuit. In some examples, a combination of processor(s), ASIC(s), and/or FPGA circuits may be included in a computer.

A computer memory can be of any suitable type, e.g., EEPROM, EPROM, ROM, Flash, hard disk drives, solid state drives, servers, or any volatile or non-volatile media. The memory can store data, e.g., a memory of an ECU 104. The memory can be a separate device from the computer, and the computer can retrieve information stored in the memory, e.g., one or more computers/ECUs 104 can obtain data to be stored via a vehicle network 112 in the vehicle 102, e.g., over an Ethernet bus, a CAN bus, a wireless network, etc. Alternatively, or additionally, the memory can be part of the computer, i.e., as a memory of the computer or firmware of a programmable chip.

The one or more computers/ECUs 104 can be included in a vehicle 102 that may be any suitable type of ground vehicle 102, e.g., a passenger or commercial automobile such as a sedan, a coupe, a truck, a sport utility, a crossover, a van, a minivan, etc. As part of an advanced driver assistance system (ADAS), computer/ECU 104 may include programming to operate one or more of vehicle 102 brakes, propulsion (e.g., control of acceleration in the vehicle 102 by controlling one or more of an internal combustion engine, electric motor, hybrid engine, etc.), steering, climate control, interior and/or exterior lights, etc., as well as to determine whether and when the computer, as opposed to a human operator, is to control such operations, such as by sending vehicle data over the vehicle network 112. Additionally, a computer/ECU 104 may be programmed to determine whether and when a human operator is to control such operations.

A vehicle computer 104 may include or be communicatively coupled to, e.g., via a vehicle network 112 such as a communications bus as described further below, more than one processor, e.g., included in sensors 108, electronic controller units (ECUs) or the like included in the vehicle 102 for monitoring and/or controlling various vehicle components, e.g., a powertrain controller, a brake controller, a steering controller, etc. The computer is generally arranged for communications on a vehicle 102 communication network that can include a bus in the vehicle 102 such as a controller area network (CAN) or the like, and/or other wired and/or wireless mechanisms. Alternatively, or additionally, in cases where the computer actually includes a plurality of devices, the vehicle network 112 may be used for communications between devices represented as the computer in this disclosure.

A vehicle 102 in accordance with the present disclosure includes a plurality of sensors 108 that may support the vehicle control assist or ADAS functions, referred to as ADAS functions for brevity. For example, sensors 108 may include, but are not limited to, one or more wheel speed sensors, GPS sensor, driver-facing camera, back-seat camera, forward-facing camera, side-facing camera, rear-facing camera, ultrasonic parking assist sensor, short range RADAR, medium range RADAR, LiDAR, light sensor, rain sensor, accelerometer, etc. Sensors 108 can support an electronic horizon function that uses cameras to detect lane lines and road curvature, sometimes in conjunction with detailed mapping data. Sensors 108 may also support a lane keep assist (LCA) function that uses one or more cameras to detect lane lines and a steering position sensor or support a drive assist function that uses one or more cameras to detect lane lines, a steering position sensor, and a driver monitoring system camera (DMSC). Sensors 108 may also support an adaptive cruise control (ACC) function that uses wheel speed sensors/GPS and/or cameras/medium range RADAR/LiDAR to support an automatic follow distance function. Sensors 108 may also support an intelligent adaptive cruise control (iACC) function that uses wheel speed sensors/GPS, cameras, and/or RADAR/LiDAR to support cruise control functions that alter vehicle speed based upon detected speed limits and road curvature. Sensors 108 can support a parking assist function that uses steering sensors, cameras, and/or ultrasonic sensors. Sensors 108 may also include those under control of a body control module (BCM), such as accelerometers, seatbelt sensors, airbag deployment sensors, and the like, which may indicate a prior incident such that an operator may desire to drive more cautiously.

A vehicle 102 in accordance with the present disclosure includes one or more ADAS settings 107 that may support the ADAS functions. For example, an ADAS settings 107 may include a set of following distance values for various speeds to be used with the ACC. An ADAS settings 107 may also include a set of cornering speed values for various speeds and radii or slew rates for use with the iACC. An ADAS settings 107 may further include a set of speed limit tolerance values for various speed limit zones/locations (Interstate, school zone, neighborhood near home, etc.) for use with the iACC. An ADAS settings 107 may also include a lane positioning preference for use with LCA or active drive assist (e.g., BlueCruise). Vehicle 102 may store a default ADAS settings 107, a pre-set ADAS settings 107 that adjusts values for more conservative driving under certain conditions (bad weather, pets or children in vehicle, drowsy driver, etc.), and, in accordance with the present disclosure, customized operator ADAS settings 107. For example, in poor driving conditions such as darkness, wet or icy roads, fog, rain, snow, etc., a follow distance may be increased, a speed limit tolerance may be reduced, a cornering speed may be reduced, etc. when the conditions still permit operation of these driver assist systems.

The vehicle network 112 is a network via which messages can be exchanged between various devices in vehicle 102. The vehicle computer 104 can be generally programmed to send and/or receive, via vehicle network 112, messages to and/or from other devices in vehicle 102 e.g., any or all of ECUs, sensors, actuators, components, communications module, a human machine interface HMI, etc. Additionally, or alternatively, messages can be exchanged among various such other devices in vehicle 102 via a vehicle network 112. In cases in which the computer includes a plurality of devices, vehicle network 112 may be used for communications between devices represented as a computer in this disclosure. In some implementations, vehicle network 112 can be a network in which messages are conveyed via a vehicle 102 communications bus. For example, vehicle network 112 can include a controller area network (CAN) in which messages are conveyed via a CAN bus, or a local interconnect network (LIN) in which messages are conveyed via a LIN bus. In some implementations, vehicle network 112 can include a network in which messages are conveyed using other wired communication technologies and/or wireless communication technologies e.g., Ethernet, WiFi, Bluetooth, Ultra-Wide Band (UWB), etc. Additional examples of protocols that may be used for communications over vehicle network 112 in some implementations include, without limitation, Media Oriented System Transport (MOST), Time-Triggered Protocol TTP, and FlexRay. In some implementations, vehicle network 112 can represent a combination of multiple networks, possibly of different types, that support communications among devices in vehicle 102. For example, vehicle network 112 can include a CAN in which some devices in vehicle 102 communicate via a CAN bus, and a wired or wireless local area network in which some device in vehicle 102 communicate according to Ethernet or WI-FI communication protocols.

The vehicle computer 104, user devices 118, and/or central computer 120 can communicate via a wide area network 116. Further, various computing devices discussed herein may communicate with each other directly, e.g., via direct radio frequency communications according to protocols such as Bluetooth or the like. For example, a vehicle 102 can include a communication module 110 to provide communications with devices and/or networks not included as part of the vehicle 102, such as the wide area network 116 and/or a user device 118, for example. The communication module 110 can provide various communications, e.g., vehicle to vehicle (V2V), vehicle-to-infrastructure or everything (V2X) or vehicle-to-everything including cellular communications (C-V2X) wireless communications cellular, dedicated short range communications (DSRC), etc., to another vehicle 102, to an infrastructure element typically via direct radio frequency communications and/or typically via the wide area network 116, e.g., to the central computer 120. The communication module 110 could include one or more mechanisms by which a vehicle computer 104 may communicate, including any desired combination of wireless e.g., cellular, wireless, satellite, microwave and radio frequency communication mechanisms and any desired network topology or topologies when a plurality of communication mechanisms are utilized. Exemplary communications provided via the module can include cellular, Bluetooth, IEEE 802.11, DSRC, cellular V2X, CV2X, and the like.

The user devices 118 may use any suitable wireless communications, such as cellular or WI-FI, such as to communicate with the central computer 120 via the wide area network 116.

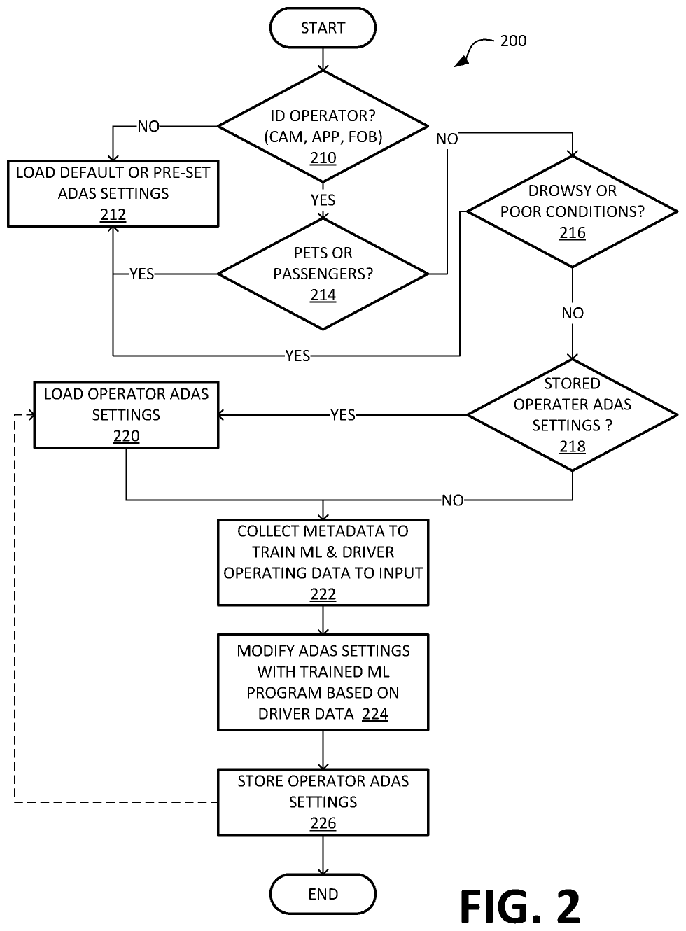

With reference to FIG. 2, a flow diagram for a process 200 for adjusting vehicle DAT by loading an ADAS setting for use by the ADAS. At block 210, a vehicle computer 104 attempts to identify the operator of the vehicle, typically when an operator starts the vehicle 102. A driver-facing camera such as the DMSC may be used to capture an image of the operator's face and facial recognition may be used to attempt to identify the operator. The communication module 110 may also connect with a user device 118 to obtain a user profile that may identify the operator or connect with an application on the user device 118 that provides identification of the operator. If the operator cannot be identified, default ADAS settings may be loaded at block 212. If the operator can be identified in block 210, the vehicle computer 104 may check for the presence of a pet, child, elder, or other passenger in the vehicle 102, at block 214. The presence of these other possible occupants may be detected via an interior camera, seatbelt sensors, seat weight sensors, and/or localization of other user devices 118, such as a spouse's smartwatch or an AirTag on a pet's collar. If a pet or passenger is detected at block 214, the default ADAS settings may be loaded or pre-set ADAS settings, such as with more conservative settings (greater follow distance values, lower corning speed values, etc. which may, for example, be determined by a machine learning program) may be loaded for use by the ADAS.

If no pets or passengers are detected at block 214, the computer 104 may check for other situations in which default or pre-set ADAS settings may be desirable at block 216. For example, the computer 104 may use the DMSC to check if the operator is drowsy, or may use light and rain sensors or electronic weather data to determine whether driving conditions are poor. If the driver is drowsy and/or the driving conditions are poor, the default or pre-set ADAS settings may be loaded at 212. If not, the computer 104 may check whether there is one or more stored operator ADAS settings at block 218. Such an operator ADAS setting may be stored memory connected to computer 104, may be stored in a database 122 accessible to computer 104 via communication module 110, or may be stored on a user device 118 that is accessible to computer 104 via communication module 110.

If it is determined at block 218 that an operator ADAS setting is stored, the operator ADAS setting is loaded at block 220 for used by the ADAS of vehicle 102.

If it is determined at block 218 that an operator ADAS setting is not stored, data on the driver is collected at block 222. Metadata on an operator's age, sex, driving experience, vehicles owned, experience with a particular vehicle, recent driving events, etc. can be retrieved by computer 104 from database 122 or can be retrieved from an app on the user device 118 of the operator (e.g., FordPass® app) that has connected with the computer 104 via communication module 110. Data on the operator's driving style can also be collected during operation of vehicle 102 by the operator to record preferred following distance values, preferred speed limit tolerance values, preferred cornering speed values, preferred lane positioning values, preferred slew rate/acceleration/braking values, preferred parking speed values, etc.

After the operator ADAS settings are loaded at block 220, additional data on the driver is collected at block 222 to refine the operator ADAS settings. Again, data on the operator's driving style can continuously or regularly be collected during operation of vehicle 102 by the operator to record additional/current preferred following distance values, preferred speed limit tolerance values, preferred cornering speed values, preferred lane change values such as how quickly they change lanes and how many lanes they are comfortable with crossing at a time or within a period of time, preferred lane positioning values, preferred slew rate/acceleration/braking values, preferred parking speed values, etc.

The data on the operator and the operator's driving style is input into a machine learning (ML) program that has been trained with data from other operators sharing similar data characteristics with the operator, such as age, sex, driving experience, vehicle type, vehicle model, and other demographic data, at block 224, to determine or select suitable modifications of the ADAS settings for the operator. At block 226, the operator ADAS setting(s) is/are stored for later use, and may, for example if the vehicle is still being operated, be loaded at block 220 for use by the ADAS.

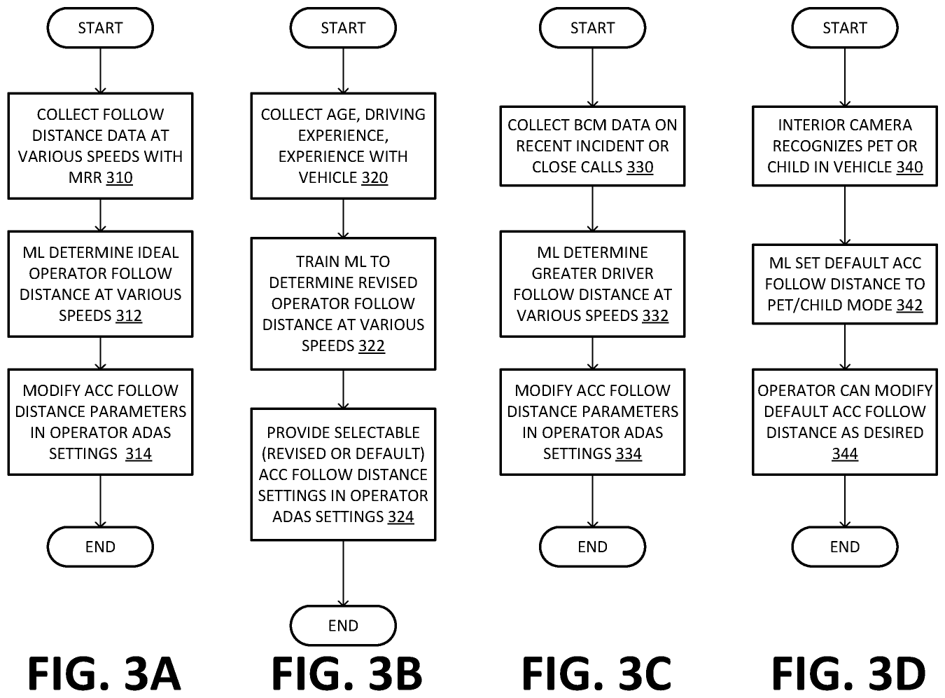

With references to FIGS. 3A, 3B, 3C, and 3D, flow diagrams for various processes related to modification of a follow distance value used by an adaptive cruise control (ACC) feature are illustrated.

In the process flow of FIG. 3A, the vehicle computer 104 may collect follow distance data at various speeds using the medium range RADAR sensor, at a first block 310, when the operator is driving the vehicle. The data is fed to the trained ML program to determine ideal follow distance values for the operator at various speeds, at block 312. The ACC follow distance parameters in the operator ADAS settings can then be modified based on the ML program output, at block 314.

In the process flow of FIG. 3B, the vehicle computer 104 may collect operator metadata such as age, driving experience, experience with vehicle 102, and other metadata (demographic, etc.), at a first block 320, when the operator starts the vehicle. This data may, for example, be gathered from an app on the operator's user device 118 or from a database 122 after identifying the operator. The data, sometimes referred to herein as metadata because it is data about or associated with a datum identifying an operator or occupant, is used to select vehicle operating data of operators having similar/matching metadata that is used to train an ML program. The trained ML program can then determine revised follow distance values for the operator at various speeds, at block 322, without necessarily having significant vehicle operation data from the identified operator. The ACC follow distance parameters in the operator ADAS settings can then be modified based on the ML program output, at block 324, and provide multiple selectable follow distances (default, revised) for the operator to select when using the ACC.

In the process flow of FIG. 3C, the vehicle computer 104 may collect data regarding recent events or close calls from the sensors of the body control module (BCM), at a first block 330, when the operator is driving the vehicle. The data is fed to the trained ML program to determine suitable post-event follow distance values for the operator at various speeds, at block 332. The ACC follow distance parameters in the operator ADAS settings can then be modified based on the ML program output, at block 324.

In the process flow of FIG. 3D, the vehicle computer 104 may collect data from internal cameras of the vehicle to determine the presence of a pet/child, at a first block 340, when the operator is driving the vehicle. The operator's data is fed to the trained ML program to determine pet/child follow distance values for the operator at various speeds. At block 342, the ACC follow distance parameters in the operator ADAS settings can then be modified based on the ML program output to a pet/child mode. In an implementation, the operator can selectively invoke/override the pet/child settings as desired, at block 344.

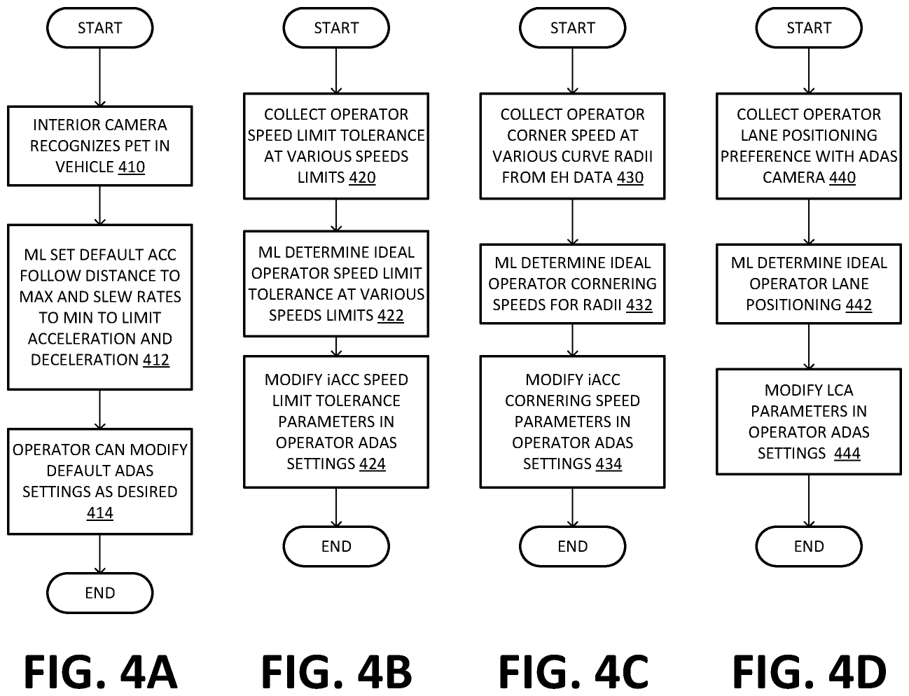

With references to FIGS. 4A, 4B, 4C, and 4D, flow diagrams for various processes related to modification of a ADAS settings values are illustrated.

In the process flow of FIG. 4A, the vehicle computer 104 may collect data from internal cameras of the vehicle to determine the presence of a pet in the vehicle, at a first block 410, when the operator is driving the vehicle. The operator's data is fed to the trained ML program to determine pet parameters for greater follow distance values for the operator at various speeds, and lower slew rates to limit acceleration and deceleration to modify the default ADAS settings with a pre-set ADAS setting for pets, at block 412. The operator can modify these pre-set ADAS settings, such as by selectively invoking/overriding the pre-set ADAS settings for pets as desired, at block 414.

In the process flow of FIG. 4B, the vehicle computer 104 may collect operator speed limit tolerance data at various speeds using the front-facing camera and speed limit recognition or map data, at a first block 420, when the operator is driving the vehicle. The data is fed to the trained ML program to determine ideal speed limit tolerance values for the operator at various speeds, at block 422. The intelligent adaptive cruise control (iACC) speed limit tolerance parameters in the operator ADAS settings can then be modified based on the ML program output, at block 424.

In the process flow of FIG. 4C, the vehicle computer 104 may collect operator corner speed data at various speeds and radii using the electronic horizon sensors of the vehicle (camera, etc.), at a first block 430, when the operator is driving the vehicle. The data is fed to the trained ML program to determine ideal cornering speed values for the operator at various speeds and radii, at block 432. The iACC follow corner speed parameters in the operator ADAS settings can then be modified based on the ML program output, at block 434.

In the process flow of FIG. 4D, the vehicle computer 104 may collect lane positioning data using the front camera and any of other LCA sensors, at a first block 440, when the operator is driving the vehicle. The data is fed to the trained ML program and combined with crowd data to determine ideal lane positioning values for the operator, at block 442. The LCA lane positioning parameters in the operator ADAS settings can then be modified based on the ML program output, at block 444.

While ADAS parameters related to ACC, iACC, and LCA have been described, similar concepts can be applied to other DAT such as park assist, overtake assist (in iACC), brake assist, and the like.

With respect to a suitable machine learning (ML) program, a dynamic neural network (DNN) may be used in an implementation of the present disclosure. A DNN can be a software program that can be loaded in memory and executed by a processor included in a computer, such as vehicle computer 104 or central computer 120 for example. In an example implementation, the DNN can include, but is not limited to, a convolutional neural network CNN, R-CNN Region-based CNN, Fast R-CNN, and Faster R-CNN. The DNN includes multiple nodes or neurons. The neurons are arranged so that the DNN includes an input layer, one or more hidden layers, and an output layer. Each layer of the DNN can include a plurality of neurons. While three hidden layers are illustrated, it is understood that the DNN can include additional or fewer hidden layers. The input and output layers may also include more than one node.

As one example, the DNN can be trained with ground truth data, i.e., data about a real-world condition or state, which in the present disclosure involves vehicle operating data from a plurality of other operators having similar/matching metadata with the identified operator. For example, the DNN can be trained with ground truth data and/or updated with additional data. Weights can be initialized by using a Gaussian distribution, for example, and a bias for each node can be set to zero. Training the DNN can include updating weights and biases via suitable techniques such as back-propagation with optimizations. Ground truth data means data deemed to represent a real-world environment, e.g., conditions and/or objects in the environment. Thus, ground truth data can include sensor data depicting an environment, e.g., a following distance, a speed, an acceleration, location, etc., along with a label or labels describing the environment, e.g., a label describing the data.

While disclosed above with respect to certain implementations, various other implementations are possible without departing from the current disclosure.

Use of in response to, based on, and upon determining herein indicates a causal relationship, not merely a temporal relationship. Further, all terms used in the claims are intended to be given their plain and ordinary meanings as understood by those skilled in the art unless an explicit indication to the contrary is made herein. Use of the singular articles “a,” “the,” etc. should be read to recite one or more of the indicated elements unless a claim recites an explicit limitation to the contrary.

In the drawings, the same reference numbers indicate the same elements. Further, some or all of these elements could be changed. With regard to the media, processes, systems, methods, etc. described herein, it should be understood that, although the steps of such processes, etc. have been described as occurring according to a certain ordered sequence, unless indicated otherwise or clear from context, such processes could be practiced with the described steps performed in an order other than the order described herein. Likewise, it further should be understood that certain steps could be performed simultaneously, that other steps could be added, or that certain steps described herein could be omitted. In other words, the descriptions of processes herein are provided for the purpose of illustrating certain implementations and should in no way be construed so as to limit the present disclosure.

The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

1. A system comprising a vehicle computer having a processor and a memory storing instructions executable by the processor to:
retrieve stored driver assistance settings of an identified operator;
collect operating behavior data about the identified operator during vehicle operation; and
select a driver assistance setting of a vehicle control assist system based on inputting the operating behavior data of the identified operator to a machine learning program trained with operating behavior data of a plurality of other operators collected during operation of a plurality of respective vehicles,
wherein metadata about the other operators have values in common with metadata of the identified operator.

2. The system of claim 1, wherein the operating behavior data of the identified operator and the other operators includes one or more of a following distance, a speed or slew rate of taking curves or corners, a speed relative to posted speed limits, a lane position, lane change behavior, acceleration behavior, braking behavior, operator drowsiness/alertness, and driving conditions.

3. The system of claim 1, wherein the driver assistance setting is one or more of a following distance of an adaptive cruise control, a cornering speed of the adaptive cruise control, a slew rate of the adaptive cruise control, an acceleration or deceleration rate of the adaptive cruise control, a speed limit tolerance of the adaptive cruise control, a lane change setting of an adaptive cruise control, and a lane keeping position of a lane keep assist.

4. The system of claim 1, wherein the metadata of the identified operator and other operators include age, amount of driving experience, amount of driving experience with the vehicle, and/or recent driving events.

5. The system of claim 1, wherein the instructions executable to collect metadata of the identified operator retrieves the metadata of the identified operator from a user device of the identified operator.

6. The system of claim 1, wherein the instructions executable to retrieve stored driver assistance settings include instructions to retrieve pre-set driver assistance settings based upon identifying occupants in the vehicle other than the operator.

7. The system of claim 6, wherein the pre-set driver assistance settings include pre-set driver assistance settings based upon identification of a pet as an occupant, identification of a child as an occupant, and/or identification of an elderly individual as an occupant.

8. The system of claim 1, wherein the instructions executable to retrieve stored driver assistance settings include instructions to retrieve pre-set driver assistance settings based upon identifying poor driving conditions.

9. The system of claim 1, further comprising instructions executable to identify occupants of the vehicle using at least one of a camera and a user device.

10. The system of claim 1, wherein the instructions to retrieve at least one of the stored driver assistance settings and the metadata of the operator includes instructions to wirelessly accesses a remote database.

11. A method to adjust a vehicle control assist system of a vehicle, comprising:
retrieving stored driver assistance settings of an identified operator for the vehicle control assist system of the vehicle;
collecting operating behavior data about the identified operator during vehicle operation; and
selecting a driver assistance setting of a vehicle control assist system based on inputting the operating behavior data of the identified operator to a machine learning program that has been trained with operating behavior data of a plurality of other operators collected during operation of a plurality of respective vehicles,
wherein metadata about the other operators have values in common with the metadata of the identified operator.

12. The method of claim 11, wherein the operating behavior data of the identified operator and the other operators includes one or more of a following distance, a speed or slew rate of taking curves or corners, a speed relative to posted speed limits, a lane position, lane change behavior, acceleration behavior, braking behavior, operator drowsiness/alertness, and driving conditions.

13. The method of claim 11, wherein the driver assistance setting is one or more of a following distance of an adaptive cruise control, a cornering speed of the adaptive cruise control, a slew rate of the adaptive cruise control, an acceleration or deceleration rate of the adaptive cruise control, a speed limit tolerance of the adaptive cruise control, a lane change setting of an adaptive cruise control, and a lane keeping position of a lane keep assist.

14. The method of claim 11, wherein the metadata of the identified operator and other operators include age, amount of driving experience, amount of driving experience with the vehicle, and/or recent driving events.

15. The method of claim 11, wherein the retrieving of the metadata of the identified operator includes retrieving the metadata of the identified operator from a user device of the identified operator.

16. The method of claim 11, wherein the retrieving of stored driver assistance settings includes retrieving pre-set driver assistance settings based upon identifying other occupants in the vehicle.

17. The method of claim 16, wherein the pre-set driver assistance settings include pre-set driver assistance settings based upon identification of a pet as an occupant, identification of a child as an occupant, and/or identification of an elderly individual as an occupant.

18. The method of claim 11, wherein the retrieving of the stored driver assistance settings includes retrieving pre-set driver assistance settings based upon identifying poor driving conditions.

19. The method of claim 11, further comprising identifying of the occupants of the vehicle using at least one of a camera and a user device.

20. The method of claim 11, wherein the retrieving of at least one of the stored driver assistance settings and the metadata of the operator includes wirelessly accessing a remote database.
